(19) United States
(12) Patent Application Publication
(10) Pub. No.: US 2003/0061091 A1
(43) Pub. Date: Mar. 27, 2003

(54) Systems and methods for making prediction on energy consumption of energy-consuming systems or sites

(76) Inventors: Mohan Mark Amaratunga, Clifton Park, NY (US); Srinivas Krishnaswamy Bagepalli, Niskayuna, NY (US); Lynn-Ann DeRose, Gloversville, NY (US); Judith Ann Guzzo, Niskayuna, NY (US); Joseph James Salvo, Schenectady, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/682,592

(22) Filed: Sep. 25, 2001

(51) Int. Cl. G06F 17/60

(52) U.S. Cl. 705/10

(57) ABSTRACT

An energy-consumption predicting system remotely measures amounts of energy consumed by energy-consuming systems or an energy-consuming site; monitors and compares the real energy usage of the systems or site against expected or predicted values for energy consumption; analyzes and determines likely causes for variances between the real and the predicted values; and recommends to the energy user actions for achieving optimum operation of the systems or site. The energy-consumption predicting system can also forecast the energy usage of the energy-consuming site. The predicted energy usage amounts are outputs of a transfer function that relates the amounts of energy consumed to the operating parameters and other energy-related variables of the energy-consuming systems or site. The energy-consumption predicting system also permits remote access and interaction by the user and allows for integrating energy-related information into an overall strategy for managing the energy-consuming site.

### CROSS REFERENCE TO RELATED APPLICATIONS

This application is related to patent application Ser. No. 09/385,510; titled “Energy Management System and Methods” filed on Aug. 30, 1999; which is incorporated herein in its entirety by reference.

### BACKGROUND OF INVENTION

The present invention relates to systems and methods for making prediction on energy consumption of energy-consuming sites. In particular, this invention relates to systems and methods for remotely acquiring data from energy-consuming systems or sites, building a model for energy consumption of an energy-consuming system or site, and providing remote access to prediction of energy consumption of the energy-consuming system or site. This invention also relates to systems and methods for providing predictions on energy consumption to an overall energy management system.

Industrial installations typically incur large expenditures for energy usage. Such expenditures often are among the largest single cost items. As the cost of energy and fuel (e.g., electricity, natural gas, diesel fuel, coal, gasoline) inevitably increases in the future, operators of these installations will become more conscious of energy efficiency and will pay close attention to the use of energy. Therefore, there is a need to acquire an ability to predict energy consumption and to compare the current energy consumption with an expected or predicted value of the same parameter so that causes of energy efficiency shortfall may be ascertained and actions, such as maintenance or rescheduling of production, taken to bring the installation back to optimum operation. It is also desirable to provide the energy user with secured access to information on his current energy usage compared to a predicted or expected amount of energy used for performing his current task. It is also desirable to link this prediction to an overall energy management system for the installation or to an optimization model for the operation thereof.

### SUMMARY OF INVENTION

A system of the present invention for predicting the energy consumption of an energy-consuming system or an energy-consuming site comprises means for measuring the energy consumption of energy-consuming areas and equipment of the energy-consuming system or site, means for determining information regarding the operation of the energy-consuming system or site, means for transmitting information about the energy consumption and the operation of the site to a means for receiving information, means for analyzing and evaluating the information, means for generating predicted or expected amounts of energy required for the operation of the energy-consuming system or site, and means for providing access to the predicted or expected amounts of required energy.

In another aspect of the present invention, the system for predicting energy consumption also comprises means for analyzing the variance between the measured and the predicted amounts of energy consumption and providing likely causes therefor.

In another aspect of the present invention, the system for predicting energy consumption also comprises means for providing predicted amounts of energy consumption to a means for optimizing the operation of the energy-consuming site.

In still another aspect of the present invention, the system for predicting energy consumption also comprises means for integrating the predicted amounts of energy consumption into an overall energy management system of the energy-consuming site.

The present invention also provides a method for predicting energy consumption of an energy-consuming system or an energy-consuming site for performing a specified operation thereat. The method comprises the steps of: measuring the energy consumption of energy-consuming areas and equipment of the energy-consuming system or site, determining information regarding the operation of the site, transmitting information about the energy consumption and the operation of the site to a means for receiving information, analyzing and evaluating the information, generating predicted or expected amounts of energy required for the operation of the energy-consuming site, and providing access to the predicted or expected amounts of required energy.

In another aspect of the present invention, the method for predicting energy consumption also comprises the steps of analyzing the variance between the measured and the predicted amounts of energy consumption and providing likely causes therefor.

In another aspect of the present invention, the method for predicting energy consumption also comprises the step of providing predicted amounts of energy consumption to a means for optimizing the operation of the energy-consuming site.

In still another aspect of the present invention, the method for predicting energy consumption also comprises the step of integrating the predicted amounts of energy consumption into an overall energy management system of the energy-consuming site.

Other aspects, advantages, and salient features of the invention also will become apparent from a perusal of the following description, which, when taken in conjunction with the accompanying drawings, in which like parts are designated by like reference characters throughout the drawings, discloses embodiments of the invention.

### BRIEF DESCRIPTION OF DRAWINGS

FIG. 1 is a simplified block, schematic diagram of a system of the present invention for predicting energy consumption of an energy-consuming site.

FIG. 2 is a flow chart for a method of the present invention for predictions on energy consumption of an energy-consuming site and for providing information to a user.

FIG. 3 is a simplified block diagram of a multi-user- and multi-site-system for making predictions on energy consumption.

### DETAILED DESCRIPTION

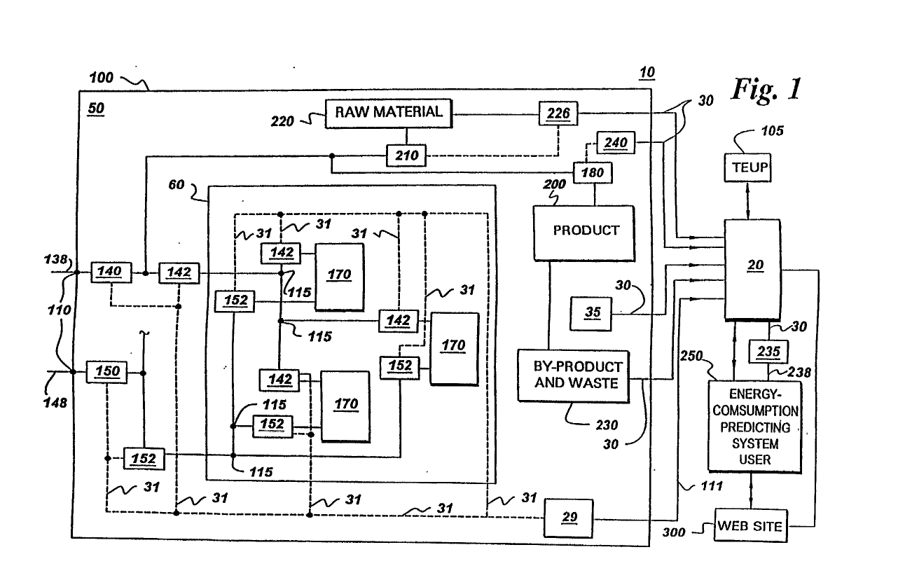

FIG. 1 shows schematically a system of the present invention for predicting energy consumption at an energy-consuming site (hereinafter called “energy-consumption predicting system”), such as a manufacturing plant or a facility that uses energy. The term “energy” as used in this disclosure means all forms of energy and fuel that are consumed to operate the energy-consuming site and include, but are not limited to electricity, natural gas, diesel fuel, gasoline, fuel oil, and coal. The energy-consumption predicting system, as embodied by the invention, comprises measurement systems and tools to measure, analyze, and evaluate amounts of consumed energy and associated methods and use of such measurement systems and tools. It is envisioned that the energy-consumption predicting system can operate independently or constitute a sub-system of an overall energy management system such as that disclosed in pending patent application Ser. No. 09/385,510; titled “Energy Management System and Methods”; filed on Aug. 30, 1999; having the same assignee. The energy-consumption predicting system can also predict aggregated energy use, for example, at one or more energy-consuming sites.

The energy-consumption predicting system monitors the current consumption of energy of an energy-consuming site by collecting data on measurements of energy delivered to an energy-consuming site and used by the energy-consuming systems, equipment, and apparatuses and on operating parameters thereof. The energy-consumption predicting system determines the expected amounts of energy consumption of an energy-consuming system when it is run efficiently, compares with the current operation of the energy-consuming system, and analyzes variances in the energy consumption. The expected or predicted amounts of energy consumption for an energy-consuming system are outputs of a transfer function for that energy-consuming system that has been developed from an initial long-term collection or from periodic update of data on energy consumption and operating characteristics of the energy-consuming system. The transfer function is a mathematical model that relates the energy consumption to the characteristic operating parameters of the energy-consuming system. The characteristic operating parameters of an energy-consuming system may include, but are not limited to, on-stream time, production rate, types of product made, types and usage quantities of raw materials, and process parameters such as operating temperature, pressure, etc. Alternatively, a transfer function may be developed that relates the total amount of a particular form of energy consumed at an energy-consuming site to the characteristic operating parameters thereof. The energy-consumption predicting system also can perform a diagnostic on the variances, presents the likely causes therefor, and makes a recommendation to the energy user regarding the operation of the energy-consuming systems, such as a maintenance action or a rescheduling of the various operations that use energy at the energy-consuming site. Wherever appropriate hardware is provided, the energy-consumption predicting system also may automatically take action by remote feedback control to bring the energy-consuming system toward its expected optimum performance. For example, if the energy-consuming system is a furnace that burns natural gas to maintain an optimum temperature, the feedback control may comprise reducing the flow of natural gas to the furnace during a period of very high ambient temperature because the heat loss from the furnace to the surroundings is lower.

The term “energy user” is used in this invention disclosure in its singular form; however, the scope of the invention is inclusive of one or more energy users. An energy user may include one multi-site company in a defined geographical area. Alternatively, the energy user may comprise one or more related or unrelated entities or companies, of any size, as described hereinafter, who have joined together to formulate and implement an overall strategy for their energy purchase to take advantage of their combined purchasing power.

The energy-consumption predicting system provides analyzed and evaluated data and information regarding the amounts of energy actually consumed, corresponding amounts of energy expected to be consumed, and operating efficiency of the energy-consuming site such as production scheduling. The data and information are accessed for developing analytical strategies and methodologies that are usable to plan estimated future energy supply and future operation of the energy-consuming site. The energy supply includes energy that is generated on site or purchased from off-site energy suppliers. The energy supply generated on site may be electricity generated by emergency generators, the operation of which requires the purchase of another form of energy, such as diesel fuel. The expenditures for such other forms of energy must be taken into consideration to provide a true assessment of the energy efficiency of the energy-consuming site. The analytical strategies and methodologies can be used for reducing the total energy supply costs and can permit an energy user to receive enhanced services from a energy provider on other energy-related matters. Further, the energy-consumption predicting system comprises analytic tools that assist an energy user to analyze energy use information and thus reduce risks associated with estimated future energy prices, plans, supplies, and related matters.

The energy-consumption predicting system may apply analytical tools to on-site energy generation, delivery, and use information to generate a total energy use profile (“TEUP”). The energy use information includes energy use data such as energy use amounts over time, and other energy-related variables, such as variables that influence energy used (collectively, “energy use information”), as needed by the energy user. The TEUP comprises, but is not limited to, a summary of energy use information, for example a profile that includes at least one of summaries, graphs, charts, and quantifications of energy use, and energy-sensitive variables that influence energy use.

The energy-consumption predicting system generates information for an energy user to plan energy supply and strategies and future operation of the energy-consuming site. For example, the energy supply strategy includes whether, how, and when to invest in capital to meet the estimated future energy usage or whether, how much, and from which suppliers to purchase additional energy. This information could also be used by an overall energy management system of an energy-consuming site or of an aggregate of related sites of a company to determine how, when, and from where to purchase energy based on analytic tools and the TEUP. Such a scenario analysis is possible with the present invention because the transfer function of the energy-consuming site can provide predicted values for energy consumption with a high degree of confidence for many hypothetical situations.

Energy-consumption predicting system 10 and the development of the transfer function for an energy-consuming site, as embodied by the invention, will now be described with respect to FIG. 1. The illustrated embodiments are merely exemplary and are not meant to limit the invention in any way. The energy-consumption predicting system 10 comprises at least one energy user component 50, which is disposed at a energy-consuming site 100. The energy-consumption predicting system 10 also comprises at least one data processing module 20, that is in direct or indirect communication with the energy user component 50 over at least one communication link 30 (hereinafter “communication link”). Therefore, depending on the nature of the communication link 30 (discussed hereinafter), the data processing module 20 can have varied locations. For example, and in no way limiting of the invention, the data processing module 20 can be disposed at the energy-consuming site 100 or disposed remote therefrom, as long as data processing module 20 is connected in communication with the energy-consuming site 100. In one embodiment of the present invention, data processing module 20 resides at a remote server that communicates with energy-consuming site 100 via secured communication links, such as those that are password-protected. In another embodiment of the present invention, data processing module 20 constitutes a central server of a computer network.

Energy user component 50 comprises one or more energy use meters and other measuring devices or sensors that can provide information on the operation of the energy-consuming site. The energy use meters (hereinafter “meters”) monitor and measure the energy amounts delivered and used. A meter may be a fuel meter 140 monitoring and measuring a fuel, such as natural gas, fuel oil, or coal, via delivery line 138; an electricity meter 150 monitoring and measuring electricity supplied via electricity supply line 148. More than one meter may be installed for one energy type if more than one source of that energy type is used. The meters may also record specific energy user information, if desired, for later transmission over communication link 30 to data processing module 20. Communication links 30 may be hard-wired or wireless telecommunication links that may be, but are not limited to, telephone lines with associated modems, radio frequency, microwave, or satellite transmission. As noted above, communication links may be secured links that protect the transmitted data. For example, the data may be encrypted or scrambled before transmission, and the encrypted or scrambled data are unencrypted or unscrambled at the receiving end for use by the energy user or by an operator of data processing module 20. A meter may store the energy user information for later transmission, if communications link 30 comprises a dial-in modem, or other interface to a communication channel, that is not in continuous communication with data processing module 20. If communication links 30 are in continuous communication with data processing module 20, then the meter need not record and store information. The following description refers to meters that monitor, measure, and record energy use information, however the recording of the energy use information is optional, depending on transmission capability of communication links 30. The scope of the invention includes any meter that can monitor, measure, and record energy use information. The meters include, but are not limited to, digital meters, analog meters, mechanical meters, broad-band spectrum modems, process logic control meters, combinations thereof, and other equivalent devices.

As illustrated in FIG. 1, meters 140 and 150 are disposed at an entry point 110 into the energy-consuming site 100 for each energy delivery line, 138 and 148, respectively to determine the delivered energy amounts. Secondary meters 142 and 152 may be disposed in the energy-consuming site 100, such as, but not limited to, disposed where energy delivery lines split and are diverted. For example, secondary meters 142 and 152 can be disposed along main and secondary delivery lines that lead to an energy-consuming system 170. Therefore, amounts of energy used by individual energy-consuming systems 170 can be measured, monitored, and recorded. At a manufacturing site, energy-consuming system 170 may typically perform any of the functions of raw material handling and preparation, production, packaging of final products, by-product and waste management, and utility management. Other areas that also consume energy are, for example, offices and laboratories. Exemplary energy-consuming systems 170 include, but are not limited to, material handling and processing equipment, fluid and solid conveying equipment, reactors, heat exchangers, phase separators, purification equipment, etc.

Also, as illustrated in FIG. 1, secondary meters 142 and 152 can be disposed at an ingress of a energy delivery line into a energy-consuming area 60. Thus, the amount of each energy type used by each energy-consuming area can be monitored, measured, and recorded. Alternatively, secondary meters 142 and 152 can be placed at branch locations (also known as “nodes”) 115 on energy delivery lines. Thus, the energy passage amount along energy delivery lines can be monitored, measured, and recorded, for example to determine leaks in gas pipelines or a high electrical resistance at branch locations 115. The number, type, and location of the meters may be determined by the energy user, for example at the time the energy-consuming site is initially surveyed for design and installation of the energy-consumption predicting system.

Each meter, 140, 142, 150, and 152, monitors, measures, and records energy amounts that pass along its respective delivery line. At appropriate locations, these meters also may measure and record other variables, such as the line temperature, pressure, particulate amount, dew point, voltage, current, etc. The meters can monitor and measure energy passage, and record energy passage amount data as a function of time. Also, the meters alternatively comprise multifunctional meters, which monitor and measure energy passage, and record energy passage amount data, along with additional energy-related and energy-dependent variables. The additional energy-related and energy-dependent variables comprise, but are not limited to, date, time, location, ambient temperature, ambient pressure, and other energy-sensitive factors that may influence energy use amounts.

The meter-generated information may be transmitted to a meter data control unit 29. Meter data control unit 29 accumulates, organizes, and then transmits the meter-generated information to data processing module 20, to be incorporated in a TEUP. Meter data control unit 29 comprises an electronic unit that can provide differing functions, such as at least one of recording, storing, time stamping, summarizing, and then transmitting of meter-generated information to data processing module 20. For example, meter data control unit 29 can electronically accumulate the meter-generated information in the form of a spreadsheet, table, and other suitable information forms. Such information may be transmitted through hard-wired or wireless communication links as previously noted. Examples for meter data control unit 29 are microcomputers, workstations, mainframe computers, program logic controllers (“PLCs”) with memory, or data acquisition electronic circuits having input and output ports. The meter-generated information is transmitted over communication link 31 to meter data control unit 29. Each communication link 31 transmits the meter-generated information in a rapid fashion, for example, but in no way limiting of the invention, electronically. Similarly, any meters directly connected to data processing module 20 also transmit the information in a rapid fashion over communication links 31. Communication link 31, and other communication links described hereinafter, include, but are not limited to, at least one of a phone modem, network connection, communication, radio communication and other wireless communication systems, cellular communication, satellite communication, web access communication (such as Internet or Intranet access communication), and combinations thereof. Alternatively, at predetermined frequency, data processing module 20 may automatically establish a link with data control unit 29 and access the data that have been stored therein since the previous data transfer event.

The meter-generated information is typically configured by meter data control unit 29 to be conveniently incorporated in a TEUP 105 that is easily usable by data processing module 20. These configurations facilitate operation of data processing module 20. Such configurations include, but are not limited to, average energy use; energy use over short time periods, such as 15-minute time periods; long time periods, such as over a day, week, month, or even a longer period; aggregation of use from one or a plurality of sites; comparison of use with historical trending information; peak energy demand profiles; and combinations thereof. Preferably, meter data control unit 29 electronically transmits the organized meter-generated information in a rapid fashion with a high degree of accuracy. For example, the meter-generated information is provided over communication link 30. Alternatively, meter-generated information may be sent directly to data processing module 20 via communication links 30 and further organized in data processing module by software provided therein.

A TEUP is developed for analysis and evaluation by data processing module 20, which in turn can analyze and evaluate the energy amounts and provide other energy use information. In this case the TEUP provides a current status and operation of the energy-consuming systems and energy-consuming site. The TEUP may comprise energy use data for each of a plurality energy-consuming sites 100. Information for the TEUP may also include particular information for each energy user component 50, energy-consuming systems 170, and each individual meter at an energy-consuming site 100. The TEUP content may be customized, for example, by an energy-consumption predicting system user 250, who may be an energy user or one responsible for managing energy-consuming site 100.

In the case in which the meter-generated information is collected and organized by meter data control unit 29, it is further transmitted to data processing module 20 over communication link 111. TEUPs 105 of one or more energy users are collected and stored by data processing module 20. Data processing module 20 analyzes and evaluates the collected data, and can comprise any device that can collect data, evaluate, and analyze data. For example, and in no way limiting of the invention, data processing module 20 comprises an analytical and electronic device, such as a main frame computer, a PLC, a data acquisition microcomputer, an analog-to-digital (A/D) converter, a digital-to-analog (D/A) converter, or combinations thereof. Data processing module 20 alternatively can comprise other appropriate solid-state devices that can collect, evaluate, and analyze data. Data processing module 20 alternatively comprises a central processor for overall, system-level control, and separate subunits performing various different specific combinations, functions, and other processes under control of the central processor section. It will be appreciated by those skilled in the art that data processing module 20 can also be implemented using a variety of separate dedicated, programmable integrated, and other electronic circuits or devices. These devices include hardwired electronic, logic circuits including discrete element circuits and programmable logic devices. Data processing module 20 can also be implemented using a suitably programmed general-purpose computer, such as, but not limited to, a microprocessor, micro-control, or other processor device having, for example, at least one central processing unit (CPU) or micro-processing unit (MPU), either alone or in conjunction with one or more peripheral data and signal processing devices. As necessary, unit 20 also may be supplemented by personnel trained to analyze and respond to the data.

Data processing module 20 can analyze TEUP 105 for each energy user component 50. Data processing module 20 is provided, either programmed with or loaded therein at the time of transmission of energy use data, with particulars of energy-consuming site 100 to formulate a TEUP. The particulars may include the number of various workers at the energy-consuming site, the scheduled downtime for maintenance, fixed energy usage independent of the production rate, etc. In addition, data processing module 20 is provided with software to perform statistical data analysis, evaluation, mathematical modeling, and optimization. The individual meters of energy-consumption predicting system 10 may comprise multifunctional meters that provide process variable information to data processing module 20, preferably through meter data control unit 29, which may preliminarily organize the data. The process variable information includes, but is not limited to, time, date, temperature, humidity, location, and other process-influencing variables. Alternatively, energy-consumption predicting system 10 comprises a separate process variable information-providing unit 35, which can provide the process variable information for a TEUP to the data processing module 20. Variable information-providing unit 35 may be provided in combination with multi-functional meters.

Other process variables that are provided to develop a TEUP include, but are not limited to, raw material information from a raw material information unit 226, by-product and waste information from a by-product and waste information unit 230, and product information from a product information unit 240. These process variables are merely exemplary, and are not meant to limit the invention in any way. Furthermore, information units 226, 230, and 240 may be combined into one integral information unit that provides variable information relating to materials at the energy-consuming site.

Another process-variable is ambient temperature. Ambient temperature will influence energy used, for example, because of the efficiency of the energy line insulation. Further, ambient temperature may also influence operations of a energy-consuming system, such as a piece of manufacturing equipment at production area 200. For example, if the production area 200 comprises an extruder that operates at a predetermined temperature, such as 250° C., and the ambient temperature is 10° C., more energy will be used to maintain the extruder temperature if energy is used to heat trace the extruder or to heat the raw material before being fed into the extruder, compared to a higher ambient temperature, for example 30° C., since less extruder heat will be lost to the surrounding environment. Energy supplied to such a production area may be measured by meter 180.

A further process-variable comprises the raw material type. The raw material type may influence the amount of energy used at the energy-consuming site 100, and its data may be provided by a raw material information unit 226. For example, raw material may be contained in storage silos that are heat traced by providing energy. If the energy-consuming equipment at production area 200 comprises an apparatus that first melts raw material using energy, differences in raw material melting temperature may influence the energy amounts used. If a provided raw material has a higher melting temperature than average raw materials, for example due to impurities in the raw material, energy amounts used to melt the provided raw material may vary and cause more energy to be used on melting the raw material. Energy supplied to such a raw material storage and handling area may be measured by meter 210.

The by-products and waste amounts for energy-consuming site 100 may similarly influence the energy amounts used. The by-products and waste amount data are provided by a by-product and waste information unit 230 that can measure by-products and waste amounts. For example, if a by-product of an energy-consuming site 100 comprises heat and if large amounts of heat above an expected amount of by-product heat are produced, a possible inefficient energy use exists. The expected amount of by-product heat may be an output provided by the energy-consumption predicting system 10 of the present invention. The energy-consumption predicting system 10 will advise an energy user of such an occurrence.

Raw material information unit 226, by-product and waste information unit 230, product information unit 240, and process variable information unit 35 may comprise computers or data memory units that include analog-to-digital or digital-to-digital converters for receiving and transferring signals from sensors or meters located throughout energy-consuming site 100.

Further, reducing the amounts of by-products and waste for the energy-consuming site 100 can represent an environmental and pollution control benefit of the energy-consumption predicting system 10. For use as in environmental and pollution control, the energy-consumption predicting system 10 measures energy used by the energy-consuming site 100 and the individual energy-consuming areas, such as 200 and 220. The amounts of pollution produced per unit energy used at each energy-consuming site 100 are known, for example from previous benchmarking and measurement. Thus, energy-consumption predicting system 10 can function to determine amounts of pollution produced by measuring the amount of energy used. The determined amounts can be useful to determine if energy-consuming systems are operating efficiently and not expelling abnormal amounts of pollution when the amounts of energy used are consistent with benchmarked amounts, or operating inefficiently, such as when amounts of energy used are significantly larger than benchmarked amounts and more pollution is being produced.

A still further process variable comprises product output information that can be provided by product information from product information unit 240. The product output, for example, parts produced over time or parts produced per energy unit by production area 200, is provided to formulate the TEUP. Product information unit 240 provides manufacturing information regarding the efficiency of the overall energy-consuming site 100 and production area 200. The manufacturing product output information includes, but is not limited to, product parts output, production run times, downtimes, and other manufacturing variables and characteristics. Product information unit 240 gathers measurements from sensors or meters that measure and record these variables. The manufacturing product output information is useful in formulating a TEUP.

Data processing module 20 also may be linked to an energy-provider database for evaluation of a TEUP. The energy-provider database typically includes energy unit prices, delivery tariffs, energy taxes, and other data that may influence the energy price. The provider data can be provided directly from an energy-provider, for example, from an energy-provider data center 235 over a communication link 30. Examples of energy-provider data centers 235 include energy-provider web pages, call-in energy-provider price updates services, and energy-provider computer servers to provide information to data processing module 20.

The energy-provider data is preferably provided in electronic form. The electronic data may be read directly into data processing module 20. Energy-consumption predicting system user 250 is also directly connected to energy-provider data center 235 over a communication link 238. Therefore, energy-consumption predicting system user 250 is able to access energy-provider information. The energy-consumption predicting system user is able to discover an energy provider's current energy prices. The energy-consumption predicting system may compare energy prices from various energy sources, and provides guidance to choose a desirable energy price. The energy-provider data is alternatively provided to energy-consumption predicting system user 250 in other forms, such as, but not limited to, oral, paper, telegraphic, pager, and non-electronic forms, which will be entered into data processing module 20.

Data processing module 20 includes software for data acquisition, data mining, and data analysis. Data processing module 20 may also include software to provide a total quality management of the systems at the energy-consuming site. Such software may include tools to provide a determination of process capability, execution of process optimization, and design for quality engineering, as well known in the art. The software enables energy management analysis, as embodied by the invention disclosed in the above-mentioned pending patent application Ser. No. 09/385,510. The software also enables purchasing, predicting energy and energy use and price trends, and planning decisions to be made based on analyzed and evaluated information. The above-mentioned software, alone or in combination with one or more information relating to production, energy providers, and the general economy, provides means for purchasing, predicting, and planning.

Data processing module 20 develops transfer functions for individual energy-consuming systems or for the overall energy-consuming site to analyze and evaluate, and predict the energy consumption of the energy-consuming systems or site. The transfer function of an energy-consuming system or site typically is the result of a regression analysis operation that models energy consumption based on variables such as process parameters of energy-consuming systems 170, mode of operation, material consumption, production, and other energy-related factors such as ambient conditions. These predictive analytical tools enable energy-consumption predicting system 10 to provide expected values for energy consumption by energy-consuming system 170 and to predict estimated future energy needs and use. These transfer functions are dependent on the nature of the energy, energy-provider controlling factors, energy-consuming site 100 particulars, details of energy-consuming systems 170, manufacturing or operating process variables, and other such factors. Thus, the user of energy-consumption predicting system 10 can use the system to develop estimated future energy use, predictive analytical tools, purchasing schemes, and other estimated future energy-related tools. Since energy-consumption predicting system 10 provides the user with expected daily energy consumption, the user can have knowledge of the daily energy efficiency of the operation of energy-consuming site 100 and, thus, can plan for maintenance work.

Energy-consumption predicting system 10 provides interactive participation for energy-consumption predicting system users, such as over a computer network or a web hook-up. Energy-consumption predicting system 10 can be password protected, if it is desired that access to the energy-consumption predicting system be limited. Other means of protecting the information, such as, but not limited to, encryption routines, and other electronic protection schemes, that allow for controlled access, are within the scope of the invention.

The information generated by energy-consumption predicting system 10 can be made available to energy-consumption predicting system user 250, for example, on a web site 300. The web site 300 can also be connected to data processing module 20 over communication links 30, such as those previously mentioned. The web site can include options that provide interactive user participation. These user-participation options include, but are not limited to, dashboards that monitor demand, alarm functions that generate alerts during the above-discussed critical events, including high and low energy prices and peak demand periods, and an “options” button that provides alternatives for reducing or delaying energy use until another time. The options may also include accepting or delaying taking action on a recommendation for maintenance of an energy-consuming system.

Energy-consumption predicting system 10 using a web site 300 provides a further benefit to a user by being able to provide real-time information to energy-consuming site 100 personnel who can readily benefit from the information. In the past, evaluations of the operation of energy-consuming system 170 occurred irregularly, and normally may not be transmitted to an operator of a energy-consuming site 100 in an expedient manner. With energy-consumption predicting system 10, energy-consuming site 100 personnel who are actually operating and controlling various energy-consuming systems, such as production equipment in production area 200 can quickly obtain analyzed and evaluated information, which is provided in a form that is valuable and easy to use. For example, an operator of a energy-consuming system can obtain information concerning the operation of the energy-consuming system quickly so as to avoid undesirable energy wastes that may result from inefficient operation of the energy-consuming system. With the real-time analyzed and evaluated information from energy-consumption predicting system 10, the operator of the energy-consuming system can take immediate steps to resolve any potentially costly wastes of energy that may otherwise have resulted. Also, with the real-time analyzed and evaluated information from energy-consumption predicting system 10, energy information feedback from a user or a customer can be received via the web (e.g., Internet or Intranet).

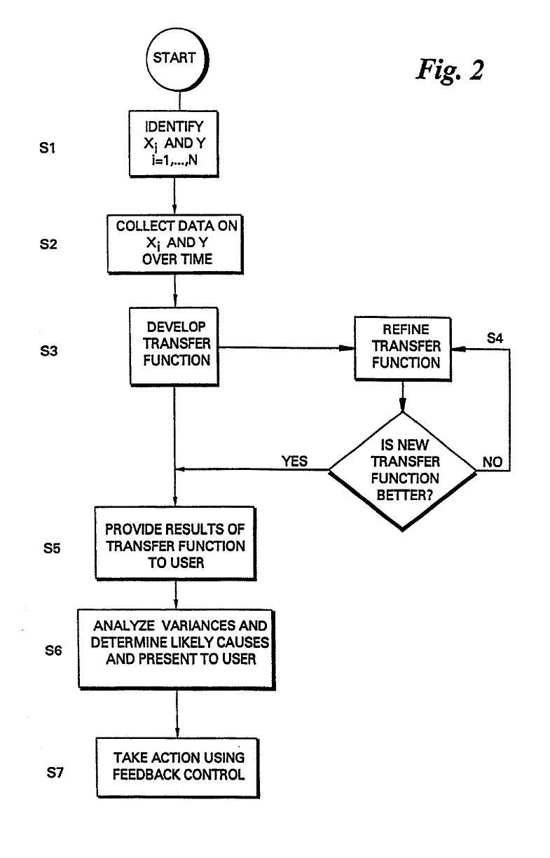

The development of a transfer function is now described with respect to an energy-consuming system with reference to the flow chart of FIG. 2. However, a transfer function of an energy-consuming site may be similarly developed. In the first step S1, the type of consumed energy and the independent variables Xᵢ (i=1, . . . , N; where N is the number of independent variables) that can influence the consumption of that type of energy by energy-consuming system 170 are identified. In step S2, data on amounts of the consumption of the particular energy (dependent variable Y) and corresponding data on independent variables Xᵢs are collected over a long period of time, such as once a shift for one year. In step S3, a regression is done on the variables Y and Xᵢs to produce a regression equation that relates Y to Xᵢs. For example, the regression equation may have the form:Y=a+ΣᵢbᵢX_{I}+Σ_{i,j}cᵢⱼXᵢXⱼ where i=1, . . . , N and j=1, . . . , N; Σᵢ denotes the sum of all the i-subscripted terms from i=1 to i=N; and Σ_{i,j} denotes the sum of all the subscripted terms from i=1 to i=N and from j=1 to j=N. The regression equation may include higher order terms when they help to provide a better fit.

The regression is the transfer function for the energy-consuming system. The result of the regression includes a set of regression coefficients, confidence interval, for example for 90% confidence, standard deviations of the coefficients and the regression line, residuals of the regression, and the correlation coefficient that provides a measure of goodness of fit of the regression. In step S4, outlying observations of Y and corresponding Xᵢs are removed from the set of observations, and the regression is rerun. The new correlation coefficient is compared to the previous correlation coefficient. If the new correlation coefficient is higher than the previous correlation coefficient, other outlying observations are further removed, and the regression is repeated. This iteration continues until the correlation coefficient starts to decrease. At that point, the set of regression coefficients for the highest correlation coefficient is used in the transfer function. In step S4, the energy user accesses data processing module 20 to obtain the transfer function and information on expected value for energy consumption by the particular energy-consuming system or site, including the variance in energy consumption. In step S5, the energy user may inquire about or data processing module may automatically present the likely causes for the variance in energy consumption. To identify the likely cause for the variance in energy consumption, data processing module 20 may examine each of the independent variables Xᵢs and compare its current value to historical data on the same variable. Any large or abrupt deviation from the historical trend can be identified as a likely contribution to the variance of energy consumption. Data processing module 20 may further perform a sensitivity analysis to provide a higher degree of confidence for the likely causes of the variance in step S6. For example, data processing module 20 may insert a value for the identified variable that is more typical of the historical data and a predicted value for energy consumption is generated. Such a sensitivity analysis can narrow the range of likely causes. Where a feedback control capability has been built into the energy-consumption predicting system, data processing module 20 may take action on the most likely causes in an attempt to bring the energy-consuming system toward a more efficient state in step S7.

Data from meters, measuring devices, and sensors at the energy-consuming systems or site continue to be collected, transferred to, and stored in data processing module 20 to further build up the historical database. At a predetermined frequency or when the energy-consuming system is significantly changed, a new regression is performed on the latest set of data to provide an update to the transfer function.

Furthermore, predicted values for energy consumption by various energy-consuming systems at an energy-consuming site that are the results of the transfer functions may be provided to an overall energy management system of the energy user to help him formulate an energy strategy for the site. Alternatively, these values may be provided to a site optimization program that also incorporates other operating characteristic variables of the site; such as the production schedule, the mix of products made, the company long-term production forecast, etc.; to provide an optimum operation of the energy-consuming site.

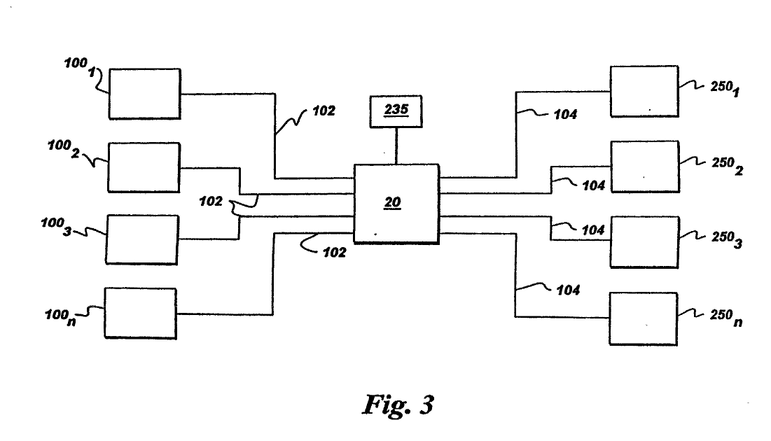

Energy-consumption predicting system 10 as illustrated in FIG. 1 is disposed at a single energy-consuming site 100. Alternatively, a plurality of energy-consuming sites can each have an energy-consumption predicting system disposed thereat. This configuration of the plurality of energy-consumption predicting systems 10 is illustrated in FIG. 3. In FIG. 3, energy-consuming sites 100₁, 100₁, 100₃, 100ₙ (for n energy-consuming sites) are interconnected, for example, over a data processing module link 102 to a data processing module 20. The plurality of energy-consuming sites 100₁, 100₂, 100₃, . . . , 100ₙ may comprise any number of sites, for example, sites from a single commercial entity, such as a large multi-location company. Energy-consuming sites 100₁, 100₂, 100₃, 100ₙ may alternatively comprise a plurality of independent companies that have joined together in an attempt to benefit from their complementary production capability. For example, an energy-consuming site 100ᵢ may produce a component that goes into the product made by energy-consuming site 100ⱼ. The results from energy-consumption predicting systems of sites 100ᵢ and 100ⱼ may be integrated to provide an overall optimum production plan for both sites.

As a further non-limiting alternative, energy-consuming sites 100₁, 100₂, 100₃, . . . 100ₙ may comprise a plurality of companies in a joint venture. Each energy-consuming site 100ᵢ (i=1, 2, . . . , n) has at least one energy-consumption predicting system 10 which together reside in data processing module 20 and are accessible over communication link 104. Data processing module 20 analyzes and evaluates the total energy use, separately or in combination, with energy-provider information 235 and provides information on predicted or expected required amounts of energy consumption to a plurality of energy-consumption predicting system users 250ⱼ (j=1, 2, . . . , n).

Energy-consumption predicting system 10 can be offered as a service by energy management service provider. Alternatively, it also may be offered by equipment manufacturers or energy providers, such as energy companies, to its current and potential energy users. Such a service provider can use energy-consumption predicting system 10 to determine how much energy has been used, historical energy use trends, estimated future energy needs for a single energy user or a group of energy users. Energy-consumption predicting system 10 may also permit the energy provider to determine how to apportion energy to each of its customers, based on the individual customer's needs and to plan for bringing on-stream additional energy generation capability. Therefore, an energy provider can apportion needed energy, as determined by energy-consumption predicting system 10 to each energy-consuming site 100 and can avoid blindly making decision regarding energy apportionment.

While various embodiments are described herein, it will be appreciated from the specification that various combinations of elements, variations, equivalents, or improvements therein may be made by those skilled in the art, and are still within the scope of the invention.

1. A energy-consumption predicting system comprising:
means for measuring amounts of energy consumed by at least one of energy-consuming site and energy-consuming systems;
means for determining information regarding an operation of said at least one of energy-consuming site and energy-consuming systems;
means for transmitting said amounts and said information to a means for receiving said amounts and said information;
means for analyzing and evaluating said amounts and said information to provide analyzed and evaluated data and information;
means for generating predicted amounts of energy required for the operation of said at least one of energy-consuming site and energy-consuming systems; and
means for providing access to said analyzed and evaluated data and information and said predicted required amounts of energy.

2. The system according to claim 1, wherein in the at least one energy-consuming site comprises at least one energy-consuming system.

3. The system according to claim 2, wherein the at least one energy-consuming system comprises a plurality of energy-consuming systems.

4. The system according to claim 1, wherein the at least one energy-consuming site comprises a plurality of energy-consuming sites.

5. The system according to claim 1, wherein the energy comprises at least one selected from the group consisting of electricity, natural gas, diesel fuel, gasoline, fuel oil, coal, and combinations thereof.

6. The system according to claim 1, wherein the means for measuring amounts of energy consumed comprises at least one meter for each type of energy consumed.

7. The system according to claim 6, wherein the at least one meter comprises a meter selected from the group consisting of digital meters, analog meters, mechanical meters, broad-band spectrum modems, process logic control meters, and combinations thereof.

8. The system according to claim 6, wherein the at least one meter comprises a meter disposed in cooperation with at least one delivery line that delivers energy to the energy-consuming site.

9. The system according to claim 8, wherein the meter that is disposed in cooperation with the at least one delivery line comprises a meter disposed prior to the energy-consuming site in a position sufficient to measure total energy amounts delivered to the energy-consuming site.

10. The system according to claim 9, wherein the energy is delivered by a method selected from the group consisting of pipeline, electrical line, delivery vehicles, and combinations thereof.

11. The system according to claim 9, wherein the meter is disposed in cooperation with the at least one delivery line comprises a meter disposed prior to each energy-consuming system in the energy-consuming site in a position sufficient to measure energy delivered to each energy-consuming system at the energy-consuming site.

12. The system according to claim 1, further comprising communications links between each of the means for measuring, the means for determining, the means for transmitting, the means for receiving, the means for analyzing and evaluating, the means for generating, and the means for providing.

13. The system according to claim 12, wherein the communications link is selected from the group consisting of phone modem, network connection, communication, radio communication and other wireless communication systems, cellular communication, satellite communication, web access communication, Internet access communication, Intranet access communication, and combinations thereof.

14. The system according to claim 1, wherein the means for analyzing and evaluating the energy amounts consumed and the information comprises at least one data processing module.

15. The system according to claim 1, wherein the means for analyzing and evaluating the energy amounts consumed and the information and the means for generating predicted amounts of energy comprise a data processing module.

16. The system according to claim 1, wherein the means for analyzing and evaluating the energy amounts consumed and the information comprises means for providing energy-provider information for evaluation and analysis.

17. The system according to claim 16, wherein the energy-provider information is provided as real-time information.

18. The system according to claim 17, wherein the energy-provider information is provided in electronic form.

19. The system according to claim 18, wherein the energy-provider information comprises at least one of energy unit prices, delivery tariffs, energy taxes, and combinations thereof.

20. The system according to claim 1, wherein the means for analyzing and evaluating the energy amounts consumed and the information comprises means for providing energy delivery information for evaluation and analysis.

21. The system according to claim 20, wherein the means for providing energy delivery information for evaluation and analysis comprises means for providing information on at least one of delivery routes, delivery costs, loss costs, tariffs, taxes, transportation costs, and combinations thereof.

22. The system according to claim 1, wherein the means for measuring energy amounts consumed at the energy-consuming site and the means for analyzing and evaluating the energy amounts consumed and the information comprise a computer.

23. The system according to claim 1, further comprising a means for providing process variable information to the means for analyzing and evaluating the energy amounts consumed and the information.

24. The system according to claim 23, wherein the means for providing process variable information provides at least one of time, date, temperature, humidity, energy-consuming site location, and other process-influencing variables for the energy-consuming site.

25. The system according to claim 23, further comprising means for providing raw material data and information to the means for analyzing and evaluating the energy amounts consumed and the information.

26. The system according to claim 23, further comprising means for providing by-product and waste information to the means for analyzing and evaluating the energy amounts consumed and the information.

27. The system according to claim 23, further comprising means for providing product information to the means for analyzing and evaluating the energy amounts consumed and the information.

28. The system according to claim 1, wherein the means for analyzing and evaluating the energy amounts consumed and the information comprises at least a means selected from the group consisting of means for acquiring data, means for mining data, and means for analyzing data.

29. The system according to claim 28, wherein each of the means for acquiring data, means for mining data, and means for analyzing data comprises data acquisition software, data mining software, data analysis software, and combinations thereof.

30. The system according to claim 1, wherein the means for analyzing and evaluating the energy amounts consumed and the information comprises at least one means selected from the group consisting of means for purchasing energy, means for predicting energy use trends, means for planning energy-related decisions, means for purchasing energy, means for predicting energy price trends, and combinations thereof.

31. The system according to claim 30, wherein the means for purchasing energy, means for predicting energy use trends, means for planning energy-related decisions, means for purchasing energy, means for predicting energy use trends, means for predicting energy price trends, and combinations thereof comprises software.

32. The system according to claim 1, further comprising a web site that is connected to the means for analyzing and evaluating to communicate energy-related information and permits access to the analyzed and evaluated data and information and the predicted amounts of energy required for said operation.

33. The system according to claim 32, wherein the web site permits a user interaction with at least one of the means for measuring, the means for determining, the means for transmitting, the means for analyzing and evaluating, the means for generating, and the means for providing.

34. The system according to claim 33, wherein the web site provides real-time analyzed and evaluated data and information and predicted required amounts of energy.

35. The system according to claim 34, wherein the means for measuring energy amounts delivered comprises at least one meter, the web site is connected to each meter of the means for measuring, and the web site permits access to meter information.

36. The system according to claim 34, wherein the means for analyzing and evaluating the energy amounts consumed and the information comprises at least one data processing module, the web site is connected to each meter of the means for measuring, and the web site permits access to the at least one data processing module.

37. The system according to claim 34, wherein the means for analyzing and evaluating the energy amounts consumed and the information comprises means to provide information on energy consumption for evaluation and analysis, the web site is connected to each meter of the means for measuring, and the web site permits access to the information on energy consumption.

38. The system according to claim 1, wherein the means for analyzing and evaluating the energy amounts consumed and the information comprises planning tools that can be used to plan at least one of future times for operation of energy-consuming systems at the energy-consuming site, future times to purchase energy, and future amounts of energy that should be purchased, as determined by the energy-consumption predicting system.

39. The system according to claim 28, wherein the means for analyzing and evaluating comprises a user interface that allows a user to relate data on amounts of energy consumed to other variables of the energy-consuming site.

40. The system according to claim 1, wherein the means for generating predicted amounts of energy required comprises software that provides a construction of a transfer function for energy consumption of the energy-consuming site.

41. The system according to claim 40, wherein the transfer function is a regression of energy consumption on other variables of the energy-consuming site.

42. An energy-consumption predicting method comprising the steps of:
measuring amounts of energy consumed by at least one of energy-consuming site and energy-consuming systems;
determining information regarding an operation of said at least one of energy-consuming site and energy-consuming systems;
transmitting said amounts and said information to a means for receiving said amounts and said information;
analyzing and evaluating said amounts and said information to provide analyzed and evaluated data and information;
generating predicted amounts of energy required for the operation of said at least one of energy-consuming site and energy-consuming systems; and
providing access to said analyzed and evaluated data and information and said predicted required amounts of energy.

43. The method according to claim 42, wherein the step of measuring the energy amounts comprises a step of measuring energy delivered to at least one energy-consuming system.

44. The method according to claim 42, wherein the step of determining the energy amounts comprises a step of measuring energy from a plurality of energy-consuming systems and a plurality of energy-consuming systems.

45. The method according to claim 42, wherein the step of measuring the energy amounts comprises measuring the amounts of at least one selected from the group consisting of electricity, natural gas, diesel fuel, gasoline, fuel oil, coal, and combinations thereof.

46. The method according to claim 42, wherein the step of measuring amounts of energy comprises measuring energy by metering the energy.

47. The method according to claim 46, wherein the step of metering comprises metering the energy amounts using a meter selected from the group consisting of digital meters, analog meters, mechanical meters, broad-band spectrum modems, process logic control meters, and combinations thereof.

48. The method according to claim 46, wherein the step of metering comprises disposing at least one meter on at least one delivery line that delivers energy to the energy-consuming site.

49. The method according to claim 48, wherein the step of disposing at least one meter comprises disposing at least one meter on the at least one delivery line and measuring a total energy amount delivered to the energy-consuming site via the at least one delivery line.

50. The method according to claim 42 further comprising interconnecting each of the means for measuring, the means for determining, the means for transmitting, the means for analyzing and evaluating, the means for generating, and the means for providing.

51. The method according to claim 50, wherein the step of interconnecting comprises providing a communication link interconnecting each of the means for measuring, the means for determining, the means for transmitting, the means for analyzing and evaluating, the means for generating, and the means for providing; the communications link being selected from the group consisting of phone modem, network connection, communication, radio communication and other wireless communication systems, cellular communication, satellite communication, web access communication, Internet access communication, Intranet access communication, and combinations thereof.

52. The method according to claim 42, wherein the step of analyzing and evaluating the energy amounts consumed and the information comprises processing the energy amounts and the information using at least one data processing module.

53. The method according to claim 42, wherein each of the step of measuring the energy amounts consumed at the energy-consuming site and the step of analyzing and evaluating the energy amounts consumed and the information comprises processing the energy amounts using at least one data processing module.

54. The method according to claim 42, wherein the step of analyzing and evaluating the energy amounts consumed and the information further comprises providing energy-provider information for evaluation and analysis.

55. The method according to claim 54, wherein the step of providing energy-provider information comprises providing real-time energy-provider information.

56. The method according to claim 55, wherein the step of providing energy-provider information comprises providing the energy-provider information in electronic form.

57. The method according to claim 55, wherein the step of providing energy-provider information comprises providing at least one of energy unit prices, delivery tariffs, energy taxes, and combinations thereof.

58. The method according to claim 42, wherein the step of analyzing and evaluating comprises providing energy delivery information for evaluation and analysis.

59. The method according to claim 58, wherein the step of providing delivery information comprises providing at least one of delivery routes, delivery costs, loss costs, tariffs, taxes, transportation costs, and combinations thereof.

60. The method according to claim 42, the method further comprising the step of providing process variable information for analyzing and evaluating the energy amounts consumed and the information.

61. The method according to claim 42, wherein the step of providing process variable information comprises providing at least one of time, date, temperature, humidity, energy-consuming site location, and other process variables for the energy-consuming site.

62. The method according to claim 42, the method further comprises the step of providing raw material data for analyzing and evaluating the energy amounts consumed and the information.

63. The method according to claim 42, the method further comprises the step of providing by-product and waste information for analyzing and evaluating the energy amounts consumed and the information.

64. The method according to claim 42, the method further comprises a step of providing raw material information for analyzing and evaluating the energy amounts consumed and the information.

65. The method according to claim 42, wherein the step of analyzing and evaluating the energy amounts consumed and the information further comprises at least one of acquiring data, mining data, and analyzing data.

66. The method according to claim 65, wherein the step of acquiring data, mining data, and analyzing data further comprises providing data acquisition software, data mining software, data analysis software, and combinations thereof.

67. The method according to claim 42, wherein the step of analyzing and evaluating the energy amounts consumed and the information further comprises developing strategies for purchasing energy, for predicting energy use trends, for planning energy-related decisions, and combinations thereof.

68. The method according to claim 42 further comprises communicating the analyzed and evaluated data and information and the predicted required amounts of energy via a web site.

69. The method according to claim 68 further comprises permitting feedback into at least one of the means for measuring, the means for determining, the means for transmitting, the means for analyzing and evaluating, the means for generating, and the means for providing.

70. The method according to claim 68, wherein the step of communicating the analyzed and evaluated data and information and the predicted required amounts of energy via a web site further comprises providing at least one of the analyzed and evaluated data and information and the predicted required amounts of energy in real-time and historical data.

71. The method according to claim 68, wherein the step of analyzing and evaluating the energy amounts consumed and the information further comprises using at least one data processing module for analyzing and evaluating, and the method further comprises connecting a web site to said at least one data processing module.

72. The method according to claim 42, wherein the predicted amounts of energy required for the operation are outputs of a transfer function that relates amounts of energy consumed to information regarding the operation.

73. The method according to claim 72, wherein the transfer function is generated in the step of analyzing and evaluating said amounts and said information.

74. The method according to claim 73, wherein the transfer function is a result of a regression of energy consumption on other variables of the energy-consuming site.

75. The method according to claim 74, wherein the transfer function is generated automatically from input data by software provided for analyzing and evaluating.
